(19) United States
(12) Patent Application Publication
(10) Pub. No.: US 2009/0156394 A1
(43) Pub. Date: Jun. 18, 2009

(54) INORGANIC SINTERED MATERIAL CONTAINING PHOTOCATALYST COVERED WITH SILICON OXIDE FILM

(75) Inventors: Nobuhiko Horiuchi, Chiba (JP); Takashi Nabeta, Chiba (JP); Satoru Miyazoe, Chiba (JP); Hiroshi Suizu, Kanagawa (JP); Toru Nonami, Aichi (JP)

Correspondence Address: BUCHANAN, INGERSOLL & ROONEY PC, POST OFFICE BOX 1404, ALEXANDRIA, VA, 22313-1404, US

(73) Assignee: MITSUI CHEMICALS, INC., Tokyo (JP)

(21) Appl. No.: 12/088,536

(22) PCT Filed: Aug. 10, 2006
(86) PCT No.: PCT/JP2006/315879

§ 371 Date: Mar. 28, 2008

(30) Foreign Application Priority Data
Sep. 30, 2005 (JP) 2005-287644

(51) Int. Cl. B01J 21/06

(52) U.S. Cl. 502/216; 502/243; 502/242

(57) ABSTRACT

The present invention is to provide an inorganic sintered material that excels in photocatalytic activity as compared with that exhibited in the use of a photocatalyst of titanium oxide only.

It is provided an inorganic sintered material comprising a photocatalyst, wherein the photocatalyst comprising a base having photocatalytic activity; and a silicon oxide film covering the base, wherein the film is substantially pore-free, and wherein the photocatalyst has a alkali metal content of not less than 1 ppm but not more than 1,000 ppm.

### TECHNICAL FIELD

The present invention relates to an inorganic sintered material having photocatalytic activity.

### BACKGROUND ART

As for an inorganic sintered material such as pottery having photocatalytic activity, a ceramic sintered material fired at a high temperature or the like, the hydrophilic property, antibiosis and decomposition activity against harmful substances have been in demand. As a substance having photocatalytic activity, when titanium oxide is applied to pottery, and if titanium oxide is present on a surface of pottery before the glaze is fired and bonded, titanium oxide is phase transited from anatase type to rutile type and sintered at the same time because the firing is carried out at a temperature of higher than 600 degree centigrade. So, the specific surface area becomes low so that the photocatalytic function cannot be exhibited. Furthermore, high temperature firing is needed for the improvement of adhesiveness even in case of the ceramic sintered material fired at a high temperature, for example, a ceramic filter or a honeycomb-like ceramic carrier. However, similarly to the case in which titanium oxide is applied to pottery, the photocatalytic function cannot be exhibited in this case either.

Accordingly, pottery having photocatalytic activity is produced through a complicated and troublesome step in which the pottery is once glazed and fired, and then covered with a substance having photocatalytic activity such as titanium oxide or the like and fired at a temperature of lower than 600 degree centigrade again for bonding to the surface of pottery. At the same time, a problem of bad adhesiveness with a glaze layer must also be solved. In order to solve the aforementioned problems, for example, a raw material containing titanium oxide particle and silica is coated on the glaze layer of a sanitary ware surface, and the resulting material is subsequently fired at a temperature of not less than 700 degree centigrade and a temperature of not more than a phase transition temperature from anatase type to rutile type for forming a photocatalyst thin film containing anatase type titanium oxide particle and silica on the glaze layer, thus aiming at improving the photocatalytic activity (Patent Document 1). However, just by physically containing titanium oxide particle and silica, it is supposed that great improvement cannot be achieved because phase transition of the titanium oxide particle can just partly be suppressed.

There have been disclosed that a silica-based film is formed by supplying organohydrogen polysiloxane to a photocatalyst in the gas phase and that the bactericidal activity under light irradiation conditions is enhanced higher than the original activity of the photocatalyst even though the photocatalyst is coated (Patent Document 2).

There has been disclosed a titanium oxide photocatalyst selectively removing a basic gas such as ammonia gas, amine-based gas or the like (Patent Document 3). The photocatalyst as described in the document has a core composed of titanium oxide particle having photocatalytic activity and a coating layer of hydrated silica surrounding around the core. The coating layer selectively adsorbs the basic gas and is efficiently supplied to the active site of titanium oxide core, whereby the coating layer functions such that the ability to eliminate the basic gas from the whole photocatalyst is enhanced.

However, in the photocatalysts described in Patent Documents 2 and 3, photodecomposition performance over organic substances is not sufficient either, and in the photocatalyst described in Patent Document 3, the adsorptive capability over harmful gas other than basic gas is insufficient. This is considered because the structure of the photocatalyst obtained by the method described in Patent Document 3, or the mechanical strength or durability of the coating layer of hydrated silica is insufficient.

Patent Document 1: Japanese Patent Laid-open No. 1999-157966

Patent Document 2: Japanese Patent Laid-open No. 1987-260717

Patent Document 3: Japanese Patent Laid-open No. 2002-159865

### DISCLOSURE OF THE INVENTION

Under the circumstances, an object of the present invention is to provide an inorganic sintered material having photocatalytic activity that is pottery or a ceramic sintered material obtained by firing at a high temperature, and a simple method for producing an inorganic sintered material having photocatalytic activity, and more specifically, in the method for producing an inorganic sintered material having photocatalytic activity, to simplify the step by performing the bonding of the photocatalyst at the time of firing and bonding of the glaze, instead of the complicated and troublesome step of firing and bonding the glaze, and then bonding the photocatalyst to the surface of pottery again.

In order to solve the aforementioned problems, the present inventors have conducted an extensive study and as a result, have found that an inorganic sintered material is provided on its surface with a photocatalyst composed of a base having photocatalytic activity and a substantially pore-free silicon oxide film covering the base wherein the content of alkali metals is in the range of not less than 1 ppm but not more than 1,000 ppm, whereby low specific surface area or phase transition to rutile caused by the use of a photocatalyst of titanium oxide only can be suppressed and high photocatalytic activity can be maintained. Thus, the present invention has been completed.

That is, according to the present invention, the following inorganic sintered material is obtained.

(1) an inorganic sintered material comprising a photocatalyst, wherein the photocatalyst comprising:

a base having photocatalytic activity; and

a silicon oxide film covering the base, wherein the film is substantially pore-free, and

wherein the photocatalyst has a alkali metal content of not less than 1 ppm but not more than 1,000 ppm.

Furthermore, according to the present invention, the following methods for producing an inorganic sintered material are provided.

(2) a method for producing pottery having a photocatalyst-containing surface layer on its surface, wherein the photocatalyst comprising a base having photocatalytic activity and a silicon oxide film covering the base, wherein the film is substantially pore-free,

wherein the method comprising the following steps (A), (B) and (C)

(A) mixing at least any one combination of an aqueous medium containing the base and a silicate, an aqueous medium containing a silicate and the base, and an aqueous medium containing the base and an aqueous medium containing a silicate, and coating the base with the silicon oxide film;

(B) separating the photocatalyst composed of the silicon oxide film and the base covered with the silicon oxide film from the aqueous medium, and drying and/or calcining the resulted material; and

(C) attaching the photocatalyst covered with said silicon oxide film to a surface of unglazed pottery and subsequently firing the resulting material at a temperature of not less than 600 degree centigrade but not more than 1,500 degree centigrade; and

wherein the pH of a mixed solution containing both the base and a silicate in step (A) is maintained at 5 or less; and

(3) a method for producing pottery having a photocatalyst-containing surface layer on its surface, wherein the photocatalyst comprising a base having photocatalytic activity and a silicon oxide film covering the base, wherein the film is substantially pore-free,

wherein the method comprising the following steps (A), (B) and (C) or (A), (B) and (D):

(A) mixing at least any one combination of an aqueous medium containing the base and a silicate, an aqueous medium containing a silicate and the base, and an aqueous medium containing the base and an aqueous medium containing a silicate, and coating the base with the silicon oxide film;

(B) separating the photocatalyst composed of the silicon oxide film and the base covered with the silicon oxide film from the aqueous medium, and drying and/or calcining the resulting material; and

(C) attaching the photocatalyst covered with said silicon oxide film to a surface of the ceramic sintered material and subsequently firing the resulting material at a temperature of not less than 600 degree centigrade but not more than 1,500 degree centigrade; or

(D) mixing the photocatalyst covered with said silicon oxide film with the raw material of said ceramic sintered material, molding the resulted mixture, and subsequently firing the resulting material at a temperature of not less than 600 degree centigrade but not more than 1,500 degree centigrade; and wherein the pH of a mixed solution containing both the base and a silicate in step (A) is maintained at 5 or less.

According to the present invention, it is possible to provide an inorganic sintered material having photocatalytic function which has remarkably high photocatalytic activity as compared with that exhibited in the use of a photocatalyst of titanium oxide only. Furthermore, according to the present invention, it is possible to provide a method for producing an inorganic sintered material excellent in photocatalytic activity conveniently and economically.

### BRIEF DESCRIPTION OF THE DRAWINGS

The aforementioned objects and other objects, characteristics and advantages become further clear by the appropriate embodiments to be described below and the following drawings accompanied thereto.

FIG. 1 is a graph showing a log differential pore volume distribution curve (a solid line) of a photocatalyst 3 and a log differential pore volume distribution curve (a dotted line) of a photocatalyst (photocatalyst 13) without having a silicon oxide film corresponding to a base of the photocatalyst 3.

FIG. 2 is a graph showing a log differential pore volume distribution curve (a solid line) of a photocatalyst 9 and a log differential pore volume distribution curve (a dotted line) of a photocatalyst (photocatalyst 19) without having a silicon oxide film corresponding to a base of the photocatalyst 9.

FIG. 3 is a graph showing a log differential pore volume distribution curve (a solid line) of a photocatalyst 37 and a log differential pore volume distribution curve (a dotted line) of a photocatalyst (photocatalyst 13) without having a silicon oxide film corresponding to a base of the photocatalyst 37.

### BEST MODE FOR CARRYING OUT THE INVENTION

The inorganic sintered material of the present invention is an inorganic sintered material containing a photocatalyst composed of a base having photocatalytic activity and a substantially pore-free silicon oxide film covering the base, wherein the content of alkali metals of the photocatalyst is in the range of 1 to 1,000 ppm (hereinafter properly simply referred to as a “silicon oxide coated photocatalyst”).

The inorganic sintered material of the present invention is obtained by combining one or more kinds of inorganic compounds as a main component and heating at a high temperature and hardening. Its composition is various depending on the combination of raw materials, and is not particularly limited. The distribution of the composition does not need to be uniform either, and may be the inside and surface, the upper part and lower part, or random distribution of the composition. The shape is not particularly limited, but examples thereof include tile, brick, tableware and the like, which are daily seen.

An inorganic compound to be a raw material (hereinafter properly simply referred to as a “raw material of inorganic sintered material”) is not particularly limited as far as it is an inorganic compound excluding a metal. It may be natural ore or clay, or may be an artificially synthesized compound such as metal oxide, metal hydroxide, inorganic salt or the like. Examples thereof include silica, aluminium oxide, zirconium dioxide, cordierite, mullite, silicon carbide, aluminum titanate, smectite, apatite and the like.

Herein, those obtained by molding using the aforementioned inorganic compound and applying a glaze after firing, and firing the resulting material are described as “pottery,” while those obtained by firing without using a glaze are described as a “ceramic sintered material.”

The silicon oxide coated photocatalyst refers to a photocatalyst having a surface of the base having photocatalytic function covered with a film made of silicon oxide. Accordingly, the silicon oxide coated photocatalyst does not include a photocatalyst bonded to silicon oxide that is produced by forming a photocatalyst later in the presence of silicon oxide or a composite formed by combining silicon oxide with a photocatalyst in the same vessel.

The type of covering the base with the silicon oxide film is not particularly limited, and includes any of coating a part of the base and coating the whole base. But, from the viewpoint that the photodecomposition activity is obtained, the whole surface of the base is preferably coated with a film made of silicon oxide all at once.

Herein, the silicon oxide film may be either a non-calcined film or a film after calcining. In the present invention, preferred is a calcined film of silicon oxide after calcining.

As a base having photocatalytic activity (hereinafter properly simply referred to as a “base”), a metal-compound photonic semiconductor can be used. Examples of the metal-compound photonic semiconductor include titanium oxide, zinc oxide, tungsten oxide, strontium titanate and the like. Among them, preferred is titanium oxide which is excellent in photocatalytic activity and stability as well, and which is harmless. Examples of titanium oxide include amorphous type titanium oxide, anatase type titanium oxide, rutile type titanium oxide, brookite type titanium oxide and the like. Of these, anatase type titanium oxide, rutile type titanium oxide or a mixture thereof excellent in the photocatalytic activity is more preferable, and a small amount of amorphous type titanium oxide may also be contained therein.

Furthermore, as a base, a particle of the metal-compound photonic semiconductor is preferably used. Further, however, a metal-compound photonic semiconductor preferably contains a base having a specific surface area of preferably not less than 30 m²/g, more preferably in the range of not less than 120 m²/g but not more than 400 m²/g and most preferably in the range of not less than 120 m²/g but not more than 300 m²/g. When the specific surface area of the base is within the above range, excellent catalytic activity can be maintained.

Meanwhile, when a base can be clearly recognized as a particle, the specific surface area of the base can be calculated by the general BET method. In other cases, based on a primary particle diameter obtained from an X-ray diffraction analysis and the calculation according to the Sheller's equation or the observation of a primary particle using an electron microscope, the “surface area” is calculated through spherical conversion and the “weight” is calculated from the true density of the crystal phase by finding out the crystal phase from the diffraction analysis of X-ray or electron beam and the volume obtained from the above spherical conversion, whereby the specific surface area of the base can be obtained.

When the base is a particle, its primary particle diameter is preferably in the range of not less than 1 nm but not more than 50 nm and more preferably in the range of not less than 2 nm but not more than 30 nm. When the primary particle diameter of the base is within this range, excellent catalytic activity can be maintained.

In the present invention, examples of the alkali metal include lithium, sodium, potassium, rubidium, cesium, francium and the like. One kind of these alkali metals may be contained, or two or more kinds thereof may be contained. Of these, preferred is sodium and/or potassium, and more preferred is sodium.

The content of alkali metals in the photocatalyst can be quantitatively analyzed by using an Atomic Adsorption Spectrophotometer (AA), an Inductively Coupled Plasma Atomic Emission Spectroscopy (ICP), an X-ray Fluorescence Spectrometer (XRF) and the like. The content of alkali metals in the silicon oxide coated photocatalyst is preferably not less than 1 ppm and more preferably not less than 10 ppm. When it is not less than 1 ppm, an effect on the improvement of the photodecomposition activity is achieved. When it is not less than 10 ppm, an effect on the improvement of the photodecomposition activity becomes remarkable. The reason why the photodecomposition activity is increased by containing a prescribed amount of the alkali metal is not always definitely clear, but it is considered so because the adsorption rate of the decomposition target is enhanced. On the other hand, the upper limit of the content of alkali metals is preferably not more than 1,000 ppm, more preferably not more than 500 ppm and further preferably not more than 200 ppm. By having the content of not more than 1,000 ppm, elution of a silicon oxide film can be suppressed. Furthermore, by having the content of not more than 500 ppm, generation of sintering of the photocatalyst in a calcination treatment at a temperature range of exceeding 800 degree centigrade can be suppressed, and by having the content of not more than 200 ppm, it is possible to make it difficult to further progress sintering of the photocatalyst.

Furthermore, the content of alkali metals contained in the silicon oxide film is preferably not less than 1 ppm but not more than 500 ppm and more preferably from 1 to 200 ppm.

The term “substantially pore-free” means that there are substantially no pores present in a silicon oxide film when the pore size distribution of a base having photocatalytic activity used as a raw material in the production of the silicon oxide film coated photocatalyst is compared with that of a silicon oxide film coated photocatalyst prepared by using the base having photocatalytic activity in the range of 20 to 500 Angstroms.

Specifically, the pore size distribution of a base having photocatalytic activity and that of a silicon oxide film coated photocatalyst are found out by the measurement of the pore size distribution such as a nitrogen adsorption method or the like, and compared to each other, whereby it is possible to determine whether there are substantially any pores present in a silicon oxide film or not.

To more specifically describe a way of finding the pore size distribution according to the nitrogen adsorption method, it is possible to determine whether there are any pores present in a silicon oxide film according to the following methods (1) to (4). Herein, an example of using a photocatalyst particle as a base will be described below.

(1) a photocatalyst particle is dried at 200 degree centigrade and then an N₂ adsorption isotherm in the desorption process is measured;

(2) an N₂ adsorption isotherm of a silicon oxide film coated photocatalyst in the desorption process is measured;

(3) the aforementioned two N₂ adsorption isotherms are interpreted by the BJH (Barrett-Joyner-Halenda) method to obtain log differential pore volume distribution curves in the range of 20 to 500 Angstroms; and

(4) by comparing two log differential pore volume distribution curves, when there is no region in which the log differential pore volume of the silicon oxide coated photocatalyst is not less than 0.1 ml/g greater than the log differential pore volume of the photocatalyst particle, it is determined that there are substantially no pores present in a silicon oxide film. On the other hand, when there is a region in which the log differential pore volume of the silicon oxide coated photocatalyst is not less than 0.1 ml/g greater than the log differential pore volume of the photocatalyst particle, it is determined that there are pores present in a silicon oxide film. Incidentally, to have a range of not less than 0.1 ml/g is because a measurement error of about 0.1 ml/g wide of the log differential pore volume value in the measurement of pore size distribution by the nitrogen adsorption method occurs in many cases.

When two log differential pore volume distribution curves are compared in the range of 20 to 500 Angstroms, existence of pores in a silicon oxide film can be substantially determined.

Furthermore, it is more preferable that two log differential pore volume distribution curves are compared and there is no region in which the log differential pore volume of the silicon oxide coated photocatalyst is not less than 0.1 ml/g greater than the log differential pore volume of the photocatalyst particle in the range of 10 to 1,000 Angstroms.

Herein, when there are pores present in the silicon oxide film, it is difficult to improve the photodecomposition activity. The reason is not always definitely clear, but it is supposedly because the diffusion or reflection of light easily occurs in the silicon oxide film due to existence of the pores for reducing light intensity of ultraviolet rays reaching the base having photocatalytic activity, and reducing the amount of holes and electrons generated by the excitation of the photocatalyst. Further, when the same amount of silicon oxide is used for coating, it is supposed that the thickness of the silicon oxide film having pores is increased more than that of the silicon oxide film having no pores as much as the volume of pores and as a result, the physical distance between the base having photocatalytic activity and the organic substance of a decomposition target becomes large so that sufficient photodecomposition activity is not achieved.

The amount of silicon supported on the aforementioned silicon oxide coated photocatalyst per a surface area 1 m² thereof is a value calculated from the amount of silicon contained in the silicon oxide coated photocatalyst and the surface area of the silicon oxide coated photocatalyst. The amount of silicon supported on the silicon oxide coated photocatalyst per a surface area 1 m² thereof is in the range of not less than 0.10 mg but not more than 2.0 mg, preferably in the range of not less than 0.12 mg but not more than 1.5 mg, more preferably in the range of not less than 0.16 mg but not more than 1.25 mg, and further preferably in the range of not less than 0.18 mg but not more than 1.25 mg. When the amount is less than 0.10 mg, an effect on the improvement of the photocatalytic activity by the silicon oxide film is small. On the other hand, when the amount exceeds 2.0 mg, the proportion of the base occupied in the silicon oxide coated photocatalyst is too lowered so that the photocatalytic function is hardly improved. The amount of loaded silicon is within the above range, whereby an effect on the improvement of the photocatalytic activity by the silicon oxide film becomes remarkable.

The surface areas of the base and the silicon oxide coated photocatalyst can be measured by using a BET method specific surface area measuring instrument by nitrogen adsorption and desorption after a heating treatment at 150 degree centigrade for 15 minutes in a dry gas flow of a dew point of not more than −195.8 degree centigrade.

The method for producing the inorganic sintered material of the present invention is characterized by maintaining the pH of the mixed solution containing both the base and a silicate at 5 or less when the aforementioned base present in an aqueous medium is covered with a silicon oxide film.

Examples of the aqueous medium in the above production method include water or a mixed solution containing water as a main component and an organic solvent capable of being dissolved in water such as aliphatic alcohols, aliphatic ethers and the like. Concrete examples of the aqueous medium include water, and a mixed solution of water and methyl alcohol, water and ethyl alcohol, water and isopropanol, and the like. Of these, water is preferable. Further, these water and mixed solution can be used singly or in combination of two or more kinds. In the aqueous medium, in order to enhance the dispersibility or solubility of the photocatalyst, an organic solvent capable of being dissolved in water such as aliphatic alcohols, aliphatic ethers and the like, and a surfactant such as aliphatic amines, aliphatic polyethers, gelatins and the like can also be further mixed.

As a silicate, a salt of a silicic acid and/or an oligomer thereof is used and it may also be used in combination of two or more kinds. Sodium salts and potassium salts are preferable from the viewpoint that they can be industrially easily available, and an aqueous solution of sodium silicate (JIS K1408 “water glass”) is further preferable since a dissolving step can be omitted.

When a base present in an aqueous medium is coated with a silicon oxide film by using a silicate, the aqueous medium, base and silicate are mixed, and the mixed solution is subsequently aged.

Specifically, a coating method includes mixing at least any one combination of (i) an aqueous medium containing a base and a silicate, (ii) an aqueous medium containing a silicate and a base, and (iii) an aqueous medium containing a base and an aqueous medium containing a silicate, and aging the mixed solution. In aging, coating of a silicon oxide film to the base is slowly progressed.

At this time, it is necessary to maintain the pH of the aqueous medium containing both the base and the silicate at 5 or less, and the pH is more preferably in acidic regions of not more than 4. When the pH is maintained at 5 or less in the absence of a base, a condensate of a silicate compound is hardly precipitated singly from a silicic acid, a silicate ion and/or an oligomer thereof. On the other hand, when the pH is maintained at 5 or less in the presence of a base, the surface of the base functions as a condensation catalyst of a silicate compound so that a silicon oxide film is quickly generated only on the surface of the base. Namely, the acidic regions of pH of 5 or less enable to make a solution containing a silicate compound stable and refer to a region capable of forming silicon oxide in the form of a film on the surface of the base.

In the basic regions of the pH of 11 or more, when a solution containing a silicic acid, a silicate ion and/or an oligomer thereof is aged similarly to the acidic regions of the pH of 5 or less, a condensate of a silicate compound is hardly precipitated. However, since a silicon oxide film is formed from only a part of the silicate in use, it is not preferable. Furthermore, since the pH range of 6 to 11 easily generates a condensate of a silicate compound, that is, a fine silicon oxide particle and/or gel, the silicon oxide film becomes porous or silicon oxide is partly formed on the surface of the base; therefore, it is not preferable.

When an organic medium such as alcohol or the like is present in an aqueous medium, since the pH cannot be accurately measured with water pH electrodes, it can be measured by using pH electrodes for an aqueous solution containing an organic medium. Separately, it is also possible to measure the pH by substituting the organic medium with water of the same volume.

As a method for maintaining the pH of the mixed solution containing both the base and the silicate at 5 or less, when the base, silicate, aqueous solvent are mixed and aged, a method in which the pH of the aqueous medium is always measured and properly adjusted by adding an acid and a base may be used. However, it is convenient if the total weight of the basic component contained in the silicate used for the production is neutralized and then an acid in an amount sufficient for the pH of 5 or less is present in the aqueous medium in advance.

Any acid can be used for an acid, but a mineral acid such as hydrochloric acid, nitric acid, sulfuric acid or the like can be properly used. Acids may be used singly or in combination of two or more kinds. Among these, hydrochloric acid and nitric acid are preferable. When sulfuric acid is used, the sulfur content remains in the photocatalyst in large quantities so that the adsorption efficiency is deteriorated over time in some cases. The sulfur content in the photocatalyst is preferably not more than 0.5 weight % and more preferably not more than 0.4 weight %, based on the total weight of the photocatalyst.

A base (alkali) is not particularly needed to use separately when the aforementioned method is employed such that the total weight of the basic component contained in the silicate is neutralized and then an acid in an amount sufficient for the pH to be 5 or less is present in the aqueous medium in advance. However, when a base (alkali) is used, any base can be used. Of such bases, alkali metal hydroxides such as potassium hydroxide, sodium hydroxide and the like can be properly used.

When the mixed solution is aged and the base is coated with a silicon oxide film, the reaction conditions such as the reaction temperature, reaction time and the like are not particularly restricted as far as generation of the desired silicon oxide coated photocatalyst is not adversely affected. The reaction temperature is preferably in the range of not less than 10 degree centigrade but not more than 200 degree centigrade and more preferably in the range of not less than 20 degree centigrade but not more than 80 degree centigrade.

When it is less than 10 degree centigrade, it becomes difficult to progress condensation of a silicate compound, whereby generation of a silicon oxide film is remarkably delayed and the deteriorated productivity of the silicon oxide coated photocatalyst might be brought about in some cases. If the temperature is higher than 200 degree centigrade, a condensate of a silicate compound, that is, a fine silicon oxide particle and/or gel is easily generated so that the silicon oxide film becomes porous or silicon oxide is partly formed on the surface of the base in some cases.

The time to age is preferably from 10 minutes to 500 hours and more preferably from 1 hour to 100 hours. When it is less than 10 minutes, coating with the silicon oxide film is not fully progressed so that an effect on the improvement of the photodecomposition activity due to a coating film might not be sufficiently achieved in some cases. When it takes longer than 500 hours, the base having photocatalytic function is sufficiently coated with the silicon oxide film and also enhances the photodecomposition function, but the productivity of the silicon oxide coated photocatalyst might be deteriorated in some cases.

Meanwhile, the concentration of the base having photocatalytic activity contained in the mixed solution is preferably in the range of not less than 1 weight % but not more than 50 weight % and more preferably in the range of not less than 5 weight % but not more than 30 weight %. When it is less than 1 weight %, the productivity of the silicon oxide coated photocatalyst might be worsened. When it is higher than 50 weight %, coating of the silicon oxide film to the base is not uniformly progressed so that an effect on the improvement of the photodecomposition activity might not be sufficiently achieved in some cases. The concentration of silicon contained in the mixed solution is preferably in the range of not less than 0.05 weight % but not more than 5 weight % and more preferably in the range of not less than 0.1 weight % but not more than 3 weight %. When the silicon concentration is less than 0.05 weight %, condensation of a silicate compound is delayed so that coating of a silicon oxide film to the base might not be sufficient in some cases. When the silicon concentration is higher than 5 weight %, coating of a silicon oxide film to the base might not be uniformly progressed in some cases.

In the production method of the silicon oxide coated photocatalyst of the present invention, the proportion of the amount of the base having photocatalytic activity and the silicate used is preferably in the range of not less than 0.01 mg/m² but not more than 0.50 mg/m² as a silicon atom per a surface area 1 m² of the above base. When the silicon oxide coated photocatalyst is produced in a proportion within the above range, in a step of forming a silicon oxide film on the surface of the base, namely, a step of mixing and aging at least any one set of an aqueous medium containing the above base and a silicate, an aqueous medium containing a silicate and the base, and an aqueous medium containing the base and an aqueous medium containing a silicate, the desired silicon oxide film can be formed on the surface of the base. At the same time, a silicon oxide film having pores might be hardly formed in some cases since the amount of a silicic acid, a silicate ion, and/or an oligomer thereof which is not condensed on the surface of the base and remained unreacted can be suppressed to small. In the range of not less than 0.50 mg/m² but not more than 5.0 mg/m², as the proportion becomes greater, the amount of the unreacted product is increased for forming a silicon oxide film having pores in some cases, but generation of pores caused by the progress of condensation of the unreacted product can be avoided by reducing the treatment time.

A concrete method for producing the aforementioned silicon oxide coated photocatalyst includes, for example, a production method including (step a) mixing at least any one combination of an aqueous medium containing a base and a silicate, an aqueous medium containing a silicate and a base, and an aqueous medium containing a base and an aqueous medium containing a silicate, (step b) aging the mixed solution and coating the aforementioned base with a silicon oxide film, (step c) separating a silicon oxide coated photocatalyst from an aqueous medium and washing without neutralizing the mixed solution, and (step d) drying and/or calcining the silicon oxide coated photocatalyst, in which, in steps (a) and (b), the pH of the aqueous medium containing both the base and the silicate is maintained at 5 or less.

When separating the silicon oxide coated photocatalyst from the aqueous medium, neutralization causes problems such that an efficiency of the reduction in the alkali metal portion at a washing step becomes worsened, and a silicon compound remained as dissolved in the aqueous medium is condensed and gelated so that a porous silica film is formed. The silicate solution is dealkalized in advance, the dealkalized solution is prepared and used for the production and the proportion of the amount of the base having photocatalytic function and the silicate used is made smaller. Thus, the above problems can also be avoided or minimized. However, when the silicon oxide coated photocatalyst is separated from the aqueous medium without being neutralized, it is preferable because the above problems can be avoided and the production method is simplified.

A method for separating the silicon oxide coated photocatalyst from the mixed solution is not particularly limited, but known methods, for example, a natural filtering method, a reduced-pressure filtering method, a pressure filtering method, a centrifugal separation method or the like can be suitably used.

A method of washing the silicon oxide coated photocatalyst is not particularly limited. However, for example, repetition of re-dispersing in pure water and filtering or desalination washing by ion exchange treatment can be suitably used. Further, when impurities such as neutralizing salts or the like occupied in the silicon oxide coated photocatalyst are small, a washing step can also be omitted.

A method of drying the silicon oxide coated photocatalyst is not particularly limited. However, for example, air drying, vacuum drying, heat drying, spray drying or the like can be suitably used. Furthermore, depending on the applications of the silicon oxide coated photocatalyst, a drying step can also be omitted.

A method of calcining the silicon oxide coated photocatalyst is not particularly limited. However, for example, vacuum calcining, air calcining, nitrogen calcining or the like can be suitably used. Usually, calcination can be carried out at a temperature of not less than 200 1,200 degree centigrade, but preferably at a temperature of not less than 400 degree centigrade but not more than 1,000 degree centigrade and more preferably at a temperature of not less than 400 degree centigrade but not more than 800 degree centigrade. When the calcining temperature is less than 200 degree centigrade, a calcined film of a desired silicon oxide is not formed on a surface of the base and its structure becomes unstable. Furthermore, a lot of water is present in the vicinity of the silicon oxide, whereby the adsorptive capability for gas is not fully exhibited and sufficient photodecomposition activity is not obtained either. When the calcining temperature is higher than 1,200 degree centigrade, sintering of the silicon oxide coated photocatalyst is progressed so that sufficient photodecomposition activity is not achieved.

The content of water contained in the silicon oxide coated photocatalyst is preferably not more than 7 weight %, further preferably not more than 5 weight %, and most preferably not more than 4 weight %. When the water content is higher than 7 weight %, a lot of water is present in the vicinity of silicon oxide, whereby the adsorptive capability for gas is not fully exhibited and sufficient photodecomposition activity is not obtained either.

The thus-obtained silicon oxide coated photocatalyst can adsorb any of acid gas such as acetic acid or the like, basic gas such as ammonia or the like, or non-polar gas such as toluene or the like, and is also excellent in photocatalytic performance.

As described above, a method for producing the silicon oxide coated photocatalyst of the present invention includes reducing the pH for obtaining a substantially pore-free silicon oxide film. At the same time, it is necessary to properly select the concentration of a silicate, the concentration of a base, an acidic solution in use, and conditions such as a calcining temperature after the formation of a film, a calcination time and the like.

The production method of pottery containing a silicon oxide coated photocatalyst is not particularly limited as far as the photocatalyst can be present on a surface of the pottery such that it can exhibit high photocatalytic activity by irradiation with light. However, for example, when it is produced by the following manner, pottery having photocatalytic function can be effectively produced.

Clay and water are mixed such that pottery is molded in a desired shape and subjected to a first firing at a temperature of not less than 600 degree centigrade but not more than 1,000 degree centigrade.

While the silicon oxide coated photocatalyst is attached to a surface of the unglazed pottery after the first firing, pottery is produced in the following method.

(1) Pottery having photocatalytic activity is obtained by mixing a glaze and silicon oxide coated photocatalyst powder, coating with the mixture and firing the resulting material at a temperature of not less than 600 degree centigrade but not more than 1,500 degree centigrade. It is desirable to perform the firing more preferably at a temperature of not less than 700 degree centigrade but not more than 1,400 degree centigrade and further preferably at a temperature of not less than 800 degree centigrade but not more than 1,300 degree centigrade for a better effect of the glaze.

Meanwhile, (2) as a separate production method, pottery having photocatalytic activity can be obtained by performing the firing at a temperature of not less than 600 degree centigrade but not more than 1,500 degree centigrade after a glaze solution is coated, and then dried at room temperature or at a low temperature of not more than 200 degree centigrade, and the silicon oxide coated photocatalyst is further coated with an aqueous dispersion, or after the silicon oxide coated photocatalyst is coated or spray coated with both a glaze and an aqueous dispersion at the same time. Also, in this case, it is desirable to perform the firing more preferably at a temperature of not less than 700 degree centigrade but not more than 1,400 degree centigrade and further preferably at a temperature of not less than 800 degree centigrade but not more than 1,300 degree centigrade.

Furthermore, (3) as a separate production method, pottery having photocatalytic activity can be obtained by performing the firing at a temperature of not less than 600 degree centigrade but not more than 1,500 degree centigrade after a glaze solution is coated, the resulting material is fired at a temperature of not less than 600 degree centigrade but not more than 1,300 degree centigrade, and then a glaze and a silicon oxide coated photocatalyst powder are further mixed and used for coating. Also, in this case, it is desirable to perform the firing more preferably at a temperature of not more than 700 degree centigrade but not more than 1,400 degree centigrade and further preferably at a temperature of not less than 800 degree centigrade but not more than 1,300 degree centigrade.

Incidentally, in the aforementioned production method of pottery having the silicon oxide coated photocatalyst, it is possible to properly omit a step of calcining in the aforementioned production method of the silicon oxide coated photocatalyst since the firing is performed at a temperature of not less than 600 degree centigrade but not more than 1,500 degree centigrade.

As a method of coating a mixture of a glaze and the aforementioned photocatalyst powder, a glaze solution or the dispersion of the aforementioned photocatalyst, a method which is generally used such as brush painting, dip coating, transcription, spray coating and the like can be used for coating.

Herein, the glaze is a blend consisting of a skeletal component (silicic acid, alumina portion) such as feldspar, clay, silica and the like, a component (alkali portion) for adjusting the temperature of melting such as sodium, potassium, calcium and the like, and a component (metals) for applying a color such as iron, copper, manganese, cobalt and the like. The glaze is applied to the surface of the unglazed pottery and the resulting material is fired, whereby feldspar and the like in the glaze is eluted at the time of firing for forming a glassy, pottery is given with luster for increasing a beautiful appearance and at the same time the strong intermediate layer capable of combining a glaze and a base body prevents water leak for solidifying the pottery.

The glaze such as a transparent glaze, a yellow-brown glaze, an ancient glaze, a celadon glaze, a talc glaze or the like can be used as an aqueous dispersion of a desired solid content concentration in the range of not less than 40 weight % but not more than 95 weight %. Furthermore, the silicon oxide coated photocatalyst can be mixed in the range of not less than 0.01 weight % but not more than 30 weight %, preferably in the range of not less than 0.05 weight % but no more than 20 weight % and more preferably in the range of not less than 0.1 weight % but not more than 10 weight %, based on the dispersion of the glaze. When the amount of the silicon oxide coated photocatalyst is excessively large, a beautiful appearance of the pottery surface is damaged, while when it is excessively small, an effect on the photocatalytic function cannot be exhibited.

The thus-obtained pottery contains a silicon oxide coated photocatalyst, and has photocatalytic functions. Regarding the shape to be used as pottery, any shape of plate-like tile, cylinder-like tableware and the like can be used as far as such a shape can exhibit the photocatalytic function effectively by irradiation with light.

And, pottery having photocatalytic activity can be used, for example, as roofing materials or outdoor tiles such as newly formed tiles for prevention of contamination, tiles or the like; as pottery made filters or wall materials inside a tank for the purpose of sterilization or pasteurization of tap water, drinking water and the like or decomposition of organic matters such as wastewater due to the industry, life and agriculture; as building interior materials for the purpose of deodorization; as side wall materials of highway for the purpose of oxidation of NOₓ and SOₓ in the air; and as tableware for household use, sanitary ware, tiles for floor materials or indoor tiles having high hydrophilic property and antibiosis.

The production method of the ceramic sintered material fired at a high temperature which has a surface layer containing a silicon oxide coated photocatalyst is not particularly limited as far as the photocatalyst can be present on a surface of the ceramic sintered material such that the photocatalyst can exhibit higher photocatalytic activity by irradiation with light. However, for example, when it is produced in the following manner, a ceramic sintered material having photocatalytic function can be effectively produced.

In order to attach the silicon oxide coated photocatalyst to the surface of the ceramic sintered material, the following method is used.

(1) A ceramic sintered material molded in a desired shape is dried at a temperature of from room temperature to 200 degree centigrade and further fired at a temperature of not less than 600 degree centigrade but not more than 1,300 degree centigrade. A binder and a silicon oxide coated photocatalyst powder are mixed thereto, and coated as an aqueous dispersion, and the resulting material is fired at a temperature of not less than 600 degree centigrade but not more than 1,500 degree centigrade to obtain a ceramic sintered material having photocatalytic activity fired at a high temperature. It is desirable to perform the firing more preferably at a temperature of not less than 600 degree centigrade but not more than 1,400 degree centigrade and further preferably at a temperature of not less than 700 degree centigrade but not more than 1,300 degree centigrade for a better effect of the binder.

Any one or more kinds of the binders including an organic binder such as methyl cellulose, polyethylene oxide, polyethylene glycol, polyvinyl alcohol, vinyl acetate, xanthan gum, sodium acrylate or the like, and an inorganic binder such as water glass, colloidal silica, alumina sol, zirconia sol, silicone resin or the like can be used as an aqueous dispersion of a desired solid content concentration in the range of about 1 to 20 weight %. Furthermore, the aforementioned silicon oxide coated photocatalyst can be mixed in the range of 0.01 to 40 weight %, preferably in the range of 0.05 to 35 weight % and more preferably in the range of 0.1 to 30 weight %, based on the dispersion. When the amount of the silicon oxide coated photocatalyst is excessively large, the photocatalyst is easily peeled away from the surface of the ceramic sintered material, while when it is excessively small, an effect on the photocatalytic function cannot be exhibited. As a method for coating the aforementioned dispersion of the photocatalyst powder, a method which is generally used such as brush painting, dip coating, transcription, spray coating, roller coating, bar coating or the like can be used.

(2) As a separate production method, when the ceramic sintered material is produced, the aforementioned silicon oxide coated photocatalyst can be mixed with the raw material of the aforementioned ceramic sintered material in the amount of not less than 0.1 weight % but not more than 50 weight %, preferably in the amount of not less than 0.3 weight % but not more than 40 weight % and more preferably in the amount of not less than 0.5 weight % but not more than 30 weight % for molding, and the resulting material can be subsequently dried at a temperature of from room temperature to 200 degree centigrade, and then fired at a temperature of not less than 400 degree centigrade but not more than 1,500 degree centigrade. In this case, it is desirable to perform the firing more preferably at a temperature of not less than 500 degree centigrade but not more than 1,400 degree centigrade and further preferably not less than 600 degree centigrade but not more than 1,300 degree centigrade.

Incidentally, in the aforementioned method for producing the ceramic sintered material containing the silicon oxide coated photocatalyst, it is possible to properly omit a step of calcination in the aforementioned production method of the silicon oxide coated photocatalyst since the firing is performed at a temperature of not less than 600 degree centigrade but not more than 1,500 degree centigrade.

The thus-obtained ceramic sintered material contains the silicon oxide coated photocatalyst, and has photocatalytic functions. Regarding the shape to be used as the ceramic sintered material, any shape of plate-like, cylinder-like, honeycomb-like, mesh-like and the like can be used as far as such a shape can exhibit photocatalytic function effectively by irradiation with light.

The ceramic sintered material having photocatalytic activity can be used, for example, as electric appliances such as air conditioner, refrigerator, humidifier, dehumidifier, air purifier and the like, dust collectors for the purpose of air purification; as ceramic sintered material filters for the purpose of sterilization or pasteurization of tap water, drinking water and the like, or decomposition of organic matters such as wastewater due to the industry, life or agriculture; as outdoor tiles, tiles for pavement, road tiles, ceramic tiles and ceramic siding materials for the purpose of prevention of contamination; and as ceramic tiles for floor materials having high hydrophilic property and antibiosis.

The silicon oxide coated photocatalyst can be preferably present on a surface of the inorganic sintered material. The surface mentioned herein refers to a part within a thickness of 2 μm from the outermost surface of the inorganic sintered material. When the photocatalyst is present in this part, the photocatalytic function can be exhibited. The part is more preferably within a thickness of 1 μm, then the photocatalytic function can be exhibited with high efficiency as compared to the amount of the photocatalyst in use. If the photocatalyst is within but more than 2 μm from the outermost surface of the inorganic sintered material, the light hardly reaches so that the photocatalytic function cannot be exhibited.

### EXAMPLES

The present invention is now illustrated in detail below with reference to Examples and Comparative Examples. However, the present invention is not restricted to these Examples and Comparative Examples.

In order to confirm the influence of the calcining temperature, the following photocatalysts were prepared.

Incidentally, the photocatalysts illustrated below have a structure such that raw material titanium dioxide is covered with a calcined film of silicon oxide, excluding a photocatalyst 43. Namely, a silicon oxide precursor film is formed on a surface of the raw material titanium dioxide and then the resulting material is calcined for forming a calcined film of silicon oxide.

### Example 1

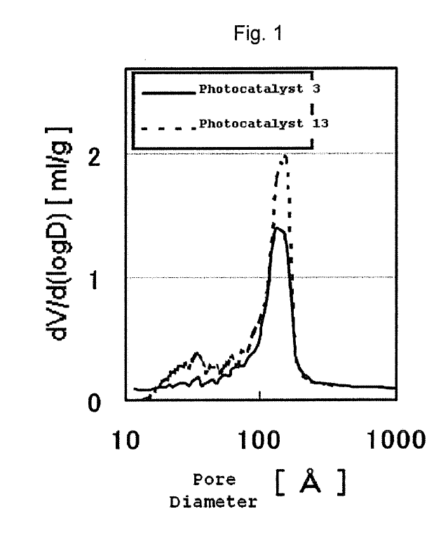

To a glass flask were added 200 g of water and 66.9 g of an aqueous solution of 1N hydrochloric acid. 24.5 g of titanium dioxide (ST-01, Ishihara Sangyo Kaisha, Ltd., adsorptive water content: 9 weight %, specific surface area by BET method specific surface area measuring instrument: 300 m²/g) was dispersed therein to give an A solution. To a beaker were added 100 g of water and 10.7 g of water glass No. 1 (SiO₂ content: 35 to 38 weight %, JIS K1408), and the resulting material was stirred to give a B solution. While the A solution was maintained at 35 degree centigrade and stirred, the B solution was added dropwise thereto at a rate of 2 ml/min. to obtain a mixed solution C. The pH of the mixed solution C at this time was 2.3. While the mixed solution C was maintained at 35 degree centigrade, it was continuously stirred for 3 days. Then, the mixed solution C was filtered under a reduced pressure. The obtained filter cake was re-dispersed in 500 mL of water and filtered under a reduced pressure repeatedly four times for washing, and then allowed to stand at room temperature for 2 days. The obtained solid was pulverized by using a mortar and then subjected to a calcination treatment at 200, 400, 600, 800, 1,000 and 1,200 degree centigrade respectively for 3 hours (photocatalysts 1 to 6). After the calcination at 600 degree centigrade for 3 hours, the pore size distribution was measured and its results are shown in FIG. 1. The sodium content of the photocatalyst 3 was quantitatively analyzed by using an atomic adsorption spectrophotometer (Z-5000, Hitachi Ltd.) and as a result, the sodium content was 87 ppm. Furthermore, the silicon content and sulfur content of the photocatalyst 3 were quantitatively analyzed by using an X-ray fluorescence spectrometry (LAB CENTER XRE-1700, Shimadzu Corp.) and as a result, the silicon content was 6.9 weight % and the sulfur content was 0.06 weight %. The specific surface area was measured by using a BET method specific surface area measuring instrument and as a result, it was 212.8 m²/g. Accordingly, the amount of silicon supported on the photocatalyst 3 per a surface area 1 m² thereof was 0.33 mg. As a result of the XRD measurement, all of the photocatalysts 1 to 5 had only the crystal structure of anatase. The photocatalyst 6 was mainly anatase, and rutile was barely seen.

### Example 2

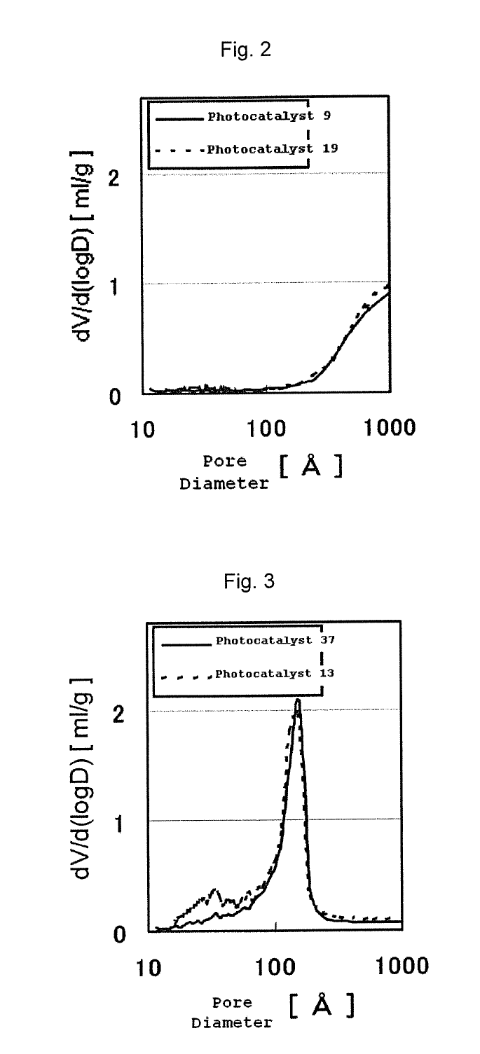

A calcination treatment was conducted at a calcining temperature of 200, 400, 600, 800, 1,000 and 1,200 degree centigrade respectively for 3 hours (photocatalysts 7 to 12) in the same manner as in Example 1, except that 75.0 g of P25 (Nippon Aerosil Co., Ltd., a mixture having a ratio of anatase to rutile of 8:2, purity: 99.5%, specific surface area by BET method specific surface area measuring instrument: 50 m²/g) was used as titanium dioxide, 6.5 g of an aqueous solution of sodium silicate was used, and the pH of the mixed solution C was 2.6. After the calcination at 600 degree centigrade for 3 hours, the pore size distribution was measured and its results are shown in FIG. 2. The sodium content of the photocatalyst 9 was 34 ppm, the silicon content was 1.4 weight %, the sulfur content was not detected and the specific surface area was 61.1 m²/g. Accordingly, the amount of silicon supported on the photocatalyst 9 per a surface area 1 m² thereof was 0.22 mg. As a result of the XRD measurement, all of the photocatalysts 7 to 11 were mainly anatase, and rutile was barely seen. The photocatalyst 12 was mainly anatase, but the intensity of rutile was increased as compared to the photocatalyst 11.

### Comparative Example 1

A commercial titanium dioxide (Ishihara Sangyo Kaisha, Ltd., ST-01) was subjected to a calcination treatment in the same manner at 200, 400, 600, 800, 1,000 and 1,200 degree centigrade respectively for 3 hours (photocatalysts 13 to 18). The sodium content of the photocatalyst 15 was quantitatively analyzed by using an atomic adsorption spectrophotometer (Z-5000, Hitachi Ltd.) and as a result, the sodium content was 1,400 ppm. As a result of the XRD measurement, the photocatalysts 13 to 15 had the crystal structure of anatase, whereas the photocatalysts 16 to 18 mainly had the crystal structure of rutile.

### Comparative Example 2

A commercial titanium dioxide (Nippon Aerosil Co., Ltd., P25) was subjected to a calcination treatment at 200, 400, 600, 800, 1,000 and 1,200 degree centigrade respectively for 3 hours (photocatalysts 19 to 24). The sodium content of the photocatalyst 21 could not be detected. According to this, it was confirmed that the photocatalysts 7 to 12 contained sodium in its calcined silicon oxide film. The specific surface area was 50.2 m²/g. As a result of the XRD measurement, the photocatalysts 19 to 21 mainly had the crystal structure of anatase, whereas the photocatalyst 22 mainly had the crystal structure of rutile, and the photocatalysts 23 and 24 had only the crystal structure of rutile.

[Evaluation of Photodecomposition Activity]

Photocatalysts 1 to 6, 9, 11, 13 to 19, 21 and 23 were suspended in an aqueous methylene blue solution. Thereafter, the resulting solution was irradiated with light and the concentration of methylene blue in the solution was quantitatively analyzed by spectrometry, whereby the photodecomposition activity was tested. The test operation method in detail is as follows.

(Preparation of Photocatalyst Suspension)

45 g of an aqueous methylene blue solution having a concentration of 40×10⁻⁶ mol/L was weighed and introduced into a 100-cc polyethylene jar with a Teflon (registered trademark) stirring bar previously arranged thereinside. Then, the resulting material was stirred by using a magnetic stirrer and 10 mg of the photocatalyst was added thereto. The resulting mixture was violently stirred for 5 minutes and then continuously stirred by adjusting the stirring strength to the extent that the solution was not flown and splashed.

### (Preliminary Adsorption Treatment)

Starting from a moment when the addition of photocatalyst was finished, stirring was continued for 60 minutes without irradiation with light. After 60 minutes passed, 3.0 cc of the suspension was collected to give a sample before irradiation with light.

(Photodecomposition Treatment)

3.5 cc of the suspension after the preliminary adsorption treatment was collected and introduced to a quartz standard spectroscopic cell (Tosoh Quartz Co., Ltd., outer size: 12.5×12.5×45 mm, optical path width: 10 mm, optical path length: 10 mm, volume: 4.5 cc) with a Teflon (registered trademark) stirring bar previously arranged thereinside, and the resulting material was stirred using a magnetic stirrer. Then, it was irradiated with light from external/transverse direction of the spectroscopic cell for 5 minutes. Irradiation with light was carried out by using a light source apparatus, SX-UI151XQ (Ushio Inc., 150 W, a xenon short-arc lamp) as a light source over a quartz filter vessel filled with pure water. The irradiated light intensity was 5.0 mW/cm² using an ultraviolet intensity meter, UVD-365 PD (Ushio Inc., test wavelength: 365 nm). After irradiation, the suspension in the spectroscopic cell was collected to give a sample after irradiation with light.

(Quantitative Analysis of Methylene Blue)

An all-plastic 10-cc syringe was equipped with a membrane filter (Toyo Roshi Kaisha, Ltd., DISMIC-13 HP). Sample suspensions before and after irradiation with light were respectively introduced thereto for removing the photocatalyst by extrusion using a piston. At that time, the first half amount of the filtrate was discarded, while the rest half amount of the filtrate was collected in a semi-micro type disposable cell (made of polystyrene, optical path width: 4 mm, optical path length: 10 mm, volume: 1.5 cc) for analysis of visible light. Then, the absorbance in a wavelength of 680 nm was measured by using a UV-visible spectrometer (UV-2500, Shimadzu Corp.) for calculating the concentration of methylene blue.

The photodecomposition activity was evaluated from the concentration of methylene blue after irradiation with light, based on the concentration of methylene blue before irradiation with light, and shown in Table 1-1 as the decomposition rate of methylene blue.

[Table 1-1]

TABLE 1-1
Decomposition Rate of Methylene Blue

| | Calcining | |
|---|---|---|
| | temperature | |
| | (degree | Decomposition rate |
| Photocatalyst | centigrade) | (%) |
| 1 | 200 | 44.9 |
| 2 | 400 | 51.0 |
| 3 | 600 | 56.1 |
| 4 | 800 | 54.1 |
| 5 | 1000 | 43.2 |
| 6 | 1200 | 32.3 |
| 9 | 600 | 69.2 |
| 11 | 1000 | 48.5 |
| 13 | 200 | 9.0 |
| 14 | 400 | 9.1 |
| 15 | 600 | 15.9 |
| 16 | 800 | 15.7 |
| 17 | 1000 | 4.2 |
| 18 | 1200 | 1.0 |
| 19 | 200 | 45.0 |
| 21 | 600 | 46.0 |
| 23 | 1000 | 4.8 |

In addition to the above photocatalysts, the following photocatalysts were prepared. The results are shown in Table 1-2 below.

(Photocatalyst 25)

A photocatalyst 25 was obtained in the same manner as in Example 1, except that the amount of titanium dioxide was 82.1 g, the pH of the mixed solution C was 4.0 and the resulting solid content was calcined at 600 degree centigrade for 3 hours. The sodium content of the photocatalyst 25 was 56 ppm, the silicon content was 2.4 weight %, and the specific surface area was 133.8 m²/g. Accordingly, the amount of silicon supported on the photocatalyst 25 per a surface area 1 m² thereof was 0.18 mg.

(Photocatalyst 26)

A photocatalyst 26 was obtained in the same manner as in the preparation method of photocatalyst 3, except that the amount of titanium dioxide was 38.9 g and the pH of the mixed solution C was 2.8. The sodium content of the photocatalyst 26 was 85 ppm, the silicon content was 4.6 weight %, and the specific surface area was 194.9 m²/g. Accordingly, the amount of silicon supported on the photocatalyst 26 per a surface area 1 m² thereof was 0.24 mg.

(Photocatalyst 27)

A photocatalyst 27 was obtained in the same manner as in the preparation method of photocatalyst 3, except that the amount of titanium dioxide was 12.2 g and the pH of the mixed solution C was 2.5. The sodium content of the photocatalyst 27 was 160 ppm, the silicon content was 9.6 weight %, and the specific surface area was 244.2 m²/g. Accordingly, the amount of silicon supported on the photocatalyst 27 per a surface area 1 m² thereof was 0.39 mg.

(Photocatalyst 28)

A photocatalyst 28 was obtained in the same manner as in the preparation method of photocatalyst 3, except that 70.5 g of PC-102 (Titan Kogyo Kabushiki Kaisha, anatase type, adsorptive water content: 5%, specific surface area by BET method specific surface area measuring instrument: 137 m²/g) was used as titanium dioxide, the pH of the mixed solution C was 3.8, and the mixed solution C was stirred for 16 hours and aged. The sodium content of the photocatalyst 28 was 12 ppm, the silicon content was 2.2 weight %, the sulfur content was 0.19 weight %, and the specific surface area was 127.8 m²/g. Accordingly, the amount of silicon supported on the photocatalyst 28 per a surface area 1 m² thereof was 0.18 mg.

(Photocatalyst 29)

A photocatalyst 29 was obtained in the same manner as in the preparation method of photocatalyst 28, except that 25.0 g of AMT-100 (Tayca Corporation, anatase type, adsorptive water content: 11%, specific surface area by BET method specific surface area measuring instrument: 290 m²/g) was used as titanium dioxide, and the pH of the mixed solution C was 2.4. The sodium content of the photocatalyst 29 was 17 ppm, the silicon content was 5.5 weight %, the sulfur content was 0.07 weight %, and the specific surface area was 207.2 m²/g. Accordingly, the amount of silicon supported on the photocatalyst 29 per a surface area 1 m² thereof was 0.27 mg.

(Photocatalyst 30)

A photocatalyst 30 was obtained in the same manner as in the preparation method of photocatalyst 28, except that 25.0 g of TKP-101 (Tayca Corporation, anatase type, adsorptive water content: 11%, specific surface area by BET method specific surface area measuring instrument: 300 m²/g) was used as titanium dioxide, and the pH of the mixed solution C was 2.1. The sodium content of the photocatalyst 30 was 50 ppm, the silicon content was 6.7 weight %, the sulfur content was 0.38 weight %, and the specific surface area was 194.2 m²/g. Accordingly, the amount of silicon supported on the photocatalyst 30 per a surface area 1 m² thereof was 0.34 mg.

(Photocatalyst 31)

A photocatalyst 31 was obtained in the same manner as in the preparation method of photocatalyst 3, except that the mixed solution C was stirred for 16 hours and aged. The sodium content of the photocatalyst 31 was 180 ppm, the silicon content was 5.7 weight %, and the specific surface area was 246.2 m²/g. Accordingly, the amount of silicon supported on the photocatalyst 30 per a surface area 1 m² thereof was 0.23 mg.

(Photocatalyst 32)

A photocatalyst 32 was obtained in the same manner as in the preparation method of photocatalyst 31, except that the resulting filter cake was re-dispersed in 500 ml of water and filtered under a reduced pressure repeatedly 7 times for washing. The sodium content of the photocatalyst 32 was 120 ppm, the silicon content was 5.7 weight %, and the specific surface area was 231.4 m²/g. Accordingly, the amount of silicon supported on the photocatalyst 31 per a surface area 1 m² thereof was 0.25 mg.

(Photocatalyst 33)

A photocatalyst 33 was obtained in the same manner as in the preparation method of photocatalyst 31, except that the resulting filter cake was re-dispersed in 500 ml of water and filtered under a reduced pressure one time for washing. The sodium content of the photocatalyst 33 was 210 ppm, the silicon content was 5.7 weight %, and the specific surface area was 231.4 m²/g. Accordingly, the amount of silicon supported on the photocatalyst 32 per a surface area 1 m² thereof was 0.24 mg.

(Photocatalyst 34)

A photocatalyst 34 was obtained in the same manner as in Example 1, except that the resulting solid content was subjected to a calcination treatment at 900 degree centigrade for 3 hours. The sodium content of the photocatalyst 34 was 96 ppm, the silicon content was 6.9 weight %, and the specific surface area was 108.2 m²/g. Accordingly, the amount of silicon supported on the photocatalyst 34 per a surface area 1 m² thereof was 0.64 mg.

(Photocatalyst 35)

A photocatalyst 35 was obtained in the same manner as in the preparation method of photocatalyst 31, except that an aqueous solution of 1N nitric acid was used in the same amount instead of an aqueous solution of 1N hydrochloric acid and the pH of the mixed solution C was 3.2. The sodium content of the photocatalyst 35 was 480 ppm, the silicon content was 6.7 weight %, and the specific surface area was 207.4 m²/g. Accordingly, the amount of silicon supported on the photocatalyst 35 per a surface area 1 m² thereof was 0.32 mg.

(Photocatalyst 36)

A photocatalyst 36 was obtained in the same manner as in the preparation method of photocatalyst 31, except that 81.7 g of an aqueous solution of 1N nitric acid was used instead of 66.9 g of an aqueous solution of 1N hydrochloric acid and 13.3 g of an aqueous solution of sodium silicate having a different composition (SiO₂ content: 29.1 weight %, Na₂O content: 9.5 weight %, JIS K1408 “Water glass No. 3”) was used. The sodium content of the photocatalyst 36 was 150 ppm, the silicon content was 3.4 weight %, and the specific surface area was 210.5 m²/g. Accordingly, the amount of silicon supported on the photocatalyst 36 per a surface area 1 m² thereof was 0.16 mg.

(Photocatalyst 37)

A photocatalyst 37 was obtained in the same manner as in the preparation method of photocatalyst 36, except that the water glass No. 1 was changed to a potassium silicate solution (Wako Pure Chemical Industries, Ltd., SiO₂ content: 28 weight %) and the amount of the potassium silicate solution was 13.8 g. The sodium content and the potassium content of the photocatalyst 37 were quantitatively analyzed by using an atomic adsorption spectrophotometer (Z-5000, Hitachi Ltd.) and as a result, the sodium content was 74 ppm and the potassium content was 90 ppm. Furthermore, the silicon content of the photocatalyst 37 was quantitatively analyzed by using an X-ray fluorescence spectrometry (LAB CENTER XRE-1700, Shimadzu Corp.) and as a result, the silicon content was 4.9 weight %, while the specific surface area was measured by a BET method specific surface area measuring instrument and as a result, it was 193.9 m²/g. Accordingly, the amount of silicon supported on the photocatalyst 37 per a surface area 1 m² thereof was 0.25 mg. The pore size distribution of the photocatalyst 37 was measured and its results are shown in FIG. 3.

As a result, it was confirmed that the photocatalyst 9 contained sodium in its calcined silicon oxide film and the photocatalyst 37 contained potassium in its calcined silicon oxide film.

Photocatalysts 38 to 42 were prepared in order to confirm the sodium content or the difference due to existence of pores derived from the silicon oxide film in the range of 20 to 500 Angstroms.

(Photocatalyst 38)

In accordance with Preparation Example 1 of Examples in Patent Document 2 (Japanese Patent Laid-open No. 1987-260717), ST-01 (Ishihara Sangyo Kaisha, Ltd., adsorptive water content: 9 weight %, specific surface area: 300 m²/g) was used as titanium dioxide to obtain a photocatalyst 38. The sodium content of the photocatalyst 38 was 1,200 ppm, the silicon content was 5.8 weight %, and the specific surface area was 187.3 m²/g. Accordingly, the amount of silicon supported on the photocatalyst 38 per a surface area 1 m² thereof was 0.31 mg.

(Photocatalyst 39)

In accordance with Preparation Example 1 of Examples in Patent Document 2 (Japanese Patent Laid-open No. 1987-260717), P25 (Nippon Aerosil Co., Ltd., purity: 99.5%, specific surface area: 50.8 m²/g) was used as titanium dioxide to obtain a photocatalyst 39. The sodium content of the photocatalyst 39 could not be detected. Meanwhile, the silicon content of the photocatalyst 39 was 2.2 weight %, and the specific surface area was 38.7 m²/g. Accordingly, the amount of silicon supported on the photocatalyst 39 per a surface area 1 m² thereof was 0.56 mg.

(Photocatalyst 40)

To a glass flask were added 250 g of water and 0.05 g of an aqueous solution of 0.1N sodium hydroxide. 24.5 g of titanium dioxide (ST-01, Ishihara Sangyo Kaisha, Ltd., adsorptive water content: 9 weight %, specific surface area: 300 m²/g) was dispersed therein to give an A solution. To a beaker were added 100 g of water and 10.7 g of an aqueous solution of sodium silicate (SiO₂ content: 36.1 weight %, Na₂O content: 17.7 weight %, JIS K1408 “Water glass No. 1”), and the resulting material was stirred to give a B solution. While the A solution was maintained at 35 degree centigrade and stirred, the B solution was added dropwise thereto at a rate of 2 ml/min. to obtain a mixed solution C. The pH of the mixed solution C at this time was 11.5. While the mixed solution C was maintained at 35 degree centigrade, it was continuously stirred for 3 days. Then, the mixed solution C was filtered under a reduced pressure. The obtained filter cake was re-dispersed in 500 ml of water and filtered under a reduced pressure repeatedly four times for washing, and then allowed to stand at room temperature for 2 days. The obtained solid was pulverized by using a mortar and then subjected to a calcination treatment at 600 degree centigrade for 3 hours to obtain a photocatalyst 40. The sodium content of the photocatalyst 40 was 14,000 ppm, the silicon content was 3.4 weight %, and the specific surface area was 126.1 m²/g. Accordingly, the amount of silicon supported on the photocatalyst 40 per a surface area 1 m² thereof was 0.27 mg.

(Photocatalyst 41)

To a glass flask was introduced 100 g of water. 10.0 g of titanium dioxide (P-25, Nippon Aerosil Co., Ltd., purity: 99.5%, specific surface area by BET method specific surface area measuring instrument: 50.8 m²/g) was dispersed therein to give an A solution. An aqueous solution of 4N sodium hydroxide was added dropwise thereto so that the pH was adjusted to 10.5. While the resulting solution was heated up to 75 degree centigrade of the liquid temperature and maintained at 75 degree centigrade, 14.8 g of an aqueous solution of sodium silicate (SiO₂ content: 29.1 weight %, Na₂O content: 9.5 weight %, JIS K1408 “Water glass No. 3”) was added thereto and the resulting material was stirred to give a B solution. While the B solution was heated up to 90 degree centigrade and maintained at 90 degree centigrade, an aqueous solution of 1N hydrochloric acid was added dropwise thereto at a rate of 2 ml/min. to give a C solution. With the dropwise addition of the aqueous solution of hydrochloric acid, the pH of the mixed solution was slowly decreased to the acidic regions from 10.5 and the final pH of the C solution became 5. Then, while the C solution was maintained at 90 degree centigrade, it was continuously stirred for 1 hour for aging. Next, the aged C solution was filtered under a reduced pressure. The obtained filter cake was re-dispersed in 250 ml of water and filtered under a reduced pressure repeatedly four times for washing, and then dried at 120 degree centigrade for 3 hours. The obtained solid was pulverized by using a mortar and then subjected to a calcination treatment at 600 degree centigrade for 3 hours to obtain a photocatalyst 41. The sodium content of the photocatalyst 39 was 2,500 ppm, the silicon content was 13.0 weight %, and the specific surface area was 68.4 m²/g. Accordingly, the amount of silicon supported on the photocatalyst 41 per a surface area 1 m² thereof was 1.90 mg.

(Photocatalyst 42)

To a glass flask was introduced 100 g of water. 4.2 g of titanium dioxide (ST-01, Ishihara Sangyo Kaisha, Ltd., adsorptive water content: 9 weight %, specific surface area by BET method specific surface area measuring instrument: 300 m²/g) was dispersed therein to give an A solution. To a beaker were added 43 g of water and 5.6 g of an aqueous solution of sodium silicate (SiO₂ content: 29.1 weight %, Na₂O content: 9.5 weight %, JIS K1408 “Water glass No. 3”), and the resulting material was stirred to give a B solution. Then, while the A solution was maintained at 35 degree centigrade and stirred, the B solution was added dropwise thereto at a rate of 2 ml/min. At this time, an aqueous solution of 1N nitric acid was added dropwise thereto in an appropriate amount such that the pH of the mixed solution was from 6 to 8. The pH of the mixed solution was 7.0 when the dropwise addition of the B solution was completed. Then, while the mixed solution was maintained at 35 degree centigrade, it was continuously stirred for 16 hours for. Next, the mixed solution was filtered under a reduced pressure. The obtained filter cake was re-dispersed in 250 mL of water and filtered under a reduced pressure repeatedly four times for washing, and then dried at 120 degree centigrade for 3 hours. The obtained solid was pulverized by using a mortar and then subjected to a calcination treatment at 600 degree centigrade for 3 hours to obtain a photocatalyst 42. The sodium content of the photocatalyst 42 was 5,900 ppm, the silicon content was 12.0 weight %, and the specific surface area was 258.3 m²/g. Accordingly, the amount of silicon supported on the photocatalyst 41 per a surface area 1 m² thereof was 0.47 mg.

(Photocatalyst 43)

With reference to Example 1 in Patent Document 3 to confirm the difference from a silica hydrate coating film, an aqueous solution of titanyl sulfate was subjected to pyrohydrolysis to prepare a metatitanic acid slurry having a crystal particle diameter of 6 nm. 100 ml of the metatitanic acid slurry (100 g/l in terms of TiO₂) was heated to 40 degree centigrade, and 5 ml of aqueous solution of sodium silicate of 200 g/l in terms of SiO₂(SiO₂/TiO₂ weight ratio=0.1) was added at a constant rate over 10 minutes. After the addition, the pH was adjusted to 4.0 with sodium hydroxide, the solution was maintained at 40 degree centigrade and stirred for 30 minutes. Thereafter, the slurry was filtered and washed, and the obtained cake was dried at 110 degree centigrade for 12 hours and then pulverized using a sample mill to obtain a photocatalyst 43. The sodium content of the photocatalyst 43 was 210 ppm, the silicon content was 5.1 weight %, the sulfur content was 0.73 weight %, and the specific surface area was 140.0 m²/g. Accordingly, the amount of silicon supported on the photocatalyst 43 per a surface area 1 m² thereof was 0.36 mg.

[Determination of Existence of Pores derived from Silicon Oxide Film by Measurement of Pore Size Distribution]

Nitrogen adsorption isotherms of photocatalysts 25 to 43 in the desorption process under liquid nitrogen (77K) were measured by using AUTOSORB (a product of Quantachrome Co., Ltd.).

As pre-treatment of each photocatalyst, vacuum degassing was carried out at 100 degree centigrade. Next, measurement results of each photocatalyst were interpreted by the BJH method and log differential pore volume distribution curves were obtained.

Next, existence of pores derived from silicon oxide films of photocatalysts 25 to 43 was determined. Specifically, log differential pore volume distribution curves of a photocatalyst used as a raw material and a photocatalyst prepared by using the aforementioned photocatalyst as a base (base catalyst) and covered with a silicon oxide film were compared for determining existence of pores derived from the silicon oxide film.

In the range of 20 to 500 Angstroms, existence of pores derived from the silicon oxide film of the photocatalysts 25 to 43 is shown in Table 1-2. Other physical properties and photocatalytic decomposition activity of the photocatalysts 25 to 43 are also shown in Table 1-2.

TABLE 1-2

| | Amount of | | | | | |
|---|---|---|---|---|---|---|
| | silicon | Amount of | | | | Pores |
| | introduced | supported | Sodium | | | derived from |
| Photocatalyst | to base | silicon | content | Adsorption | Decomposition | silicon |
| No. | (mg/m²) | (mg/m²) | (ppm) | rate (%) | Rate (%) | oxide film |
| 25 | 0.07 | 0.18 | 56 | 6.6 | 51.9 | No |
| 26 | 0.15 | 0.24 | 85 | 21.2 | 52.5 | No |
| 27 | 0.48 | 0.39 | 160 | 45.5 | 46.7 | No |
| 28 | 0.20 | 0.18 | 12 | 9.3 | 56.1 | No |
| 29 | 0.28 | 0.27 | 17 | 30.7 | 54.5 | No |
| 30 | 0.28 | 0.34 | 50 | 22.5 | 59.4 | No |
| 31 | 0.24 | 0.23 | 180 | 43.2 | 57.9 | No |
| 32 | 0.24 | 0.25 | 120 | 40.6 | 53.8 | No |
| 33 | 0.24 | 0.24 | 210 | 44.9 | 51.9 | No |
| 34 | 0.24 | 0.64 | 96 | 35.0 | 48.0 | No |
| 35 | 0.24 | 0.32 | 480 | 39.4 | 59.9 | No |
| 36 | 0.24 | 0.16 | 150 | 29.5 | 55.9 | No |
| 37 | 0.24 | 0.25 | 74 | 23.6 | 49.2 | No |
| 38 | — | 0.31 | 1200 | 57.8 | 31.0 | No |
| 39 | — | 0.56 | not detected | 17.5 | 31.5 | No |
| 40 | 0.24 | 0.27 | 14000 | 47.1 | 36.2 | Yes |
| 41 | 3.99 | 1.90 | 2500 | 11.0 | 22.0 | Yes |
| 42 | 0.59 | 0.47 | 5900 | 56.8 | 38.7 | Yes |
| 43 | 0.50 | 0.36 | 210 | 3.5 | 2.2 | No |

[Differential Thermogravimetric Analysis]

In order to examine the water content of the silicon oxide coated photocatalyst, the differential thermogravimetric analysis (Thermo Plus TG8120, Rigaku) was performed. In an air gas flow with a flow rate of 50 ml/min, the temperature was elevated from room temperature to 600 degree centigrade at a rate of 10 degree centigrade/min so that the weight loss rate at that time was measured.

In order to eliminate the influence of moisture absorption as much as possible after each sample was dried or calcined, the water content was measured after each sample was dried or calcined and cooled for 1 hour. Water contents of the photocatalysts 1, 3, 9 and 43 are shown in Table 1-3.

TABLE 1-3

| | Weight loss |
|---|---|
| | rate (%) |
| Photocatalyst 1 | 4.9 |
| Photocatalyst 3 | 0.9 |
| Photocatalyst 9 | 0.6 |
| Photocatalyst 43 | 8.9 |

### Example 3

0.5 g of the photocatalyst 3 was mixed to 100 g (solid content: 70%) of a dispersion of a talc glaze. 0.1 g of the resulting mixture was coated on a surface of an unglazed tile in a size of 5 cm in width, 5 cm in length and 5 mm in thickness using a brush, and the resulting material was dried at room temperature, and then fired at 1,000 degree centigrade for 1 hour to obtain a photocatalyst tile 1.

### Comparative Example 3

A photocatalyst tile 2 was obtained in the same manner as in Example 3 by using titanium dioxide (Ishihara Sangyo Kaisha, Ltd., ST-01) instead of the photocatalyst 3.

[Evaluation of Methylene Blue Decomposition Activity]

In order to confirm photocatalytic function of the thus-prepared tiles, the decomposition activity of methylene blue was tested. The aforementioned photocatalyst tiles 1 and 2 were placed in a Petri dish having a diameter of 9 cm, 15 ml of aqueous methylene blue solution having a concentration of 40×10⁻⁶ mol/L was put thereinto, and the resulting material was allowed to stand at a dark place for 60 minutes. Thereafter, 3 ml of the solution was collected and the absorbance was measured by using a spectrophotometer for calculating the concentration of methylene blue before irradiation with light. The solution after the measurement of the absorbance was put back into the Petri dish and irradiation with light was carried out by using a black light (Sankyo Denki Co., Ltd., 27W) as a light source. The irradiated light intensity was 1.0 mW/cm² using an ultraviolet intensity meter, UVD-365PD (Ushio Inc., test wavelength: 365 nm). After irradiation was carried out with the black light for 24 hours, 3 ml of the solution was collected and the absorbance was measured by using a spectrophotometer for calculating the concentration of methylene blue after irradiation with light. The photodecomposition activity was evaluated from the concentration of methylene blue after irradiation with light, based on the concentration of methylene blue before irradiation with light, and shown in Table 2 as decomposition rate of methylene blue.

[Table 2]

TABLE 2
Decomposition activity of methylene blue

| Photocatalyst | Decomposition rate |
|---|---|
| Tile | (%) |
| 1 | 12.2 |
| 2 | 0.4 |

### Example 4

0.5 g of the photocatalyst 3 was mixed to 100 g (solid content: 70%) of a dispersion of a talc glaze. 0.5 g of the resulting mixture was coated on a surface of a glaze finished tile in a size of 5 cm in width, 5 cm in length and 5 mm in thickness using a brush, and the resulting material was dried at room temperature, and then fired at 1,000, 1,100 and 1,200 degree centigrade for 1 hour to obtain photocatalyst tiles 3, 4 and 5.

### Example 5

Photocatalyst tiles 6, 7 and 8 were obtained by firing at a temperature of 1,000, 1,100 and 1,200 degree centigrade for 1 hour in the same manner as in Example 4, except that the photocatalyst 3 was changed to the photocatalyst 9.

### Example 6

A photocatalyst tile 9 was obtained by firing at a temperature of 1,000 degree centigrade in the same manner as in Example 4 using the photocatalyst 36 instead of the photocatalyst 3.

### Comparative Example 4

A photocatalyst tile 10 was obtained by firing at a temperature of 1,000 degree centigrade for 1 hour in the same manner as in Example 4 using titanium dioxide (Ishihara Sangyo Kaisha, Ltd., ST-01) instead of the photocatalyst 3.

### Comparative Example 5

A photocatalyst tile 11 was obtained by firing at a temperature of 1,000 degree centigrade for 1 hour in the same manner as in Example 4 using titanium dioxide (Nippon Aerosil Co., Ltd., P25) instead of the photocatalyst 3.

### Comparative Example 6

A photocatalyst tile 12 was obtained by firing at a temperature of 1,000 degree centigrade in the same manner as in Example 4 using the photocatalyst 40 instead of the photocatalyst 3. However, since the sodium content in the photocatalyst is large, sintering was progressed and the appearance was bad. The test on evaluation of hydrophilic property to be described below could not be performed.

### Example 7

0.5 g of the photocatalyst 3 was mixed to 0.5 g of methyl cellulose, 2 g of Snowtex O (Nissan Chemical Industries, Ltd., SiO₂: 20 weight %) and 97.5 g of water (solid content: 70%). 0.2 g of the resulting mixture was coated on a surface of an alumina plate in a size of 5 cm in width, 5 cm in length and 5 mm in thickness using a brush, and the resulting material was dried at 120 degree centigrade for 3 hours, and then fired at 800, 900 and 1,000 degree centigrade for 2 hours to obtain photocatalyst alumina plates 1, 2 and 3.

### Example 8

A photocatalyst alumina plate 4 was obtained by firing at a temperature of 800 degree centigrade in the same manner as in Example 7 using the photocatalyst 36 instead of the photocatalyst 3.

### Comparative Example 7

A photocatalyst alumina plate 5 was obtained by firing at a temperature of 800 degree centigrade for 2 hours in the same manner as in Example 7 using titanium dioxide (Ishihara Sangyo Kaisha, Ltd., ST-01) instead of the photocatalyst 3.

### Comparative Example 8

A photocatalyst alumina plate 6 was obtained by firing at a temperature of 800 degree centigrade in the same manner as in Example 7 using the photocatalyst 40 instead of the photocatalyst 3.

[Evaluation of Hydrophilic Property]

In order to confirm the photocatalytic function of the photocatalyst tiles and photocatalyst alumina plates prepared as described above, evaluation of hydrophilic property was carried out by measuring the contact angle of water. Photocatalyst tiles 3 to 12 and photocatalyst alumina plates 1 to 6 were irradiated with light using a black light (Sankyo Denki Co., Ltd., 27W) as a light source. The irradiated light intensity was 1.0 mW/cm² using an ultraviolet intensity meter, UVD-365PD (Ushio Inc., test wavelength: 365 nm). Irradiation with the black light was performed for 48 hours, a waterdrop was dropped for measuring the contact angle, and the change according to the irradiation time was examined. The results thereof were shown in Tables 3 and 4.

[Table 3]

TABLE 3
Contact angle of water upon irradiation with light (°)

| Photocatalyst | Time for irradiation with light (hour) | | |
|---|---|---|---|
| tile | 0 | 24 | 48 |
| 3 | 46 | 5 | 0 |
| 4 | 47 | 10 | 1 |
| 5 | 48 | 13 | 8 |
| 6 | 45 | 5 | 0 |
| 7 | 47 | 11 | 1 |
| 8 | 49 | 14 | 7 |
| 9 | 48 | 9 | 2 |
| 10 | 44 | 42 | 40 |
| 11 | 45 | 44 | 43 |

[Table 4]

TABLE 4
Contact angle of water upon irradiation with light (°)

| Photocatalyst | Time for irradiation with light (hour) | | |
|---|---|---|---|
| alumina plate | 0 | 24 | 48 |
| 1 | 42 | 2 | 0 |
| 2 | 43 | 4 | 0 |
| 3 | 44 | 6 | 2 |
| 4 | 45 | 10 | 4 |
| 5 | 42 | 40 | 38 |
| 6 | 44 | 37 | 33 |

1. An inorganic sintered material comprising a photocatalyst, wherein the photocatalyst comprising:
a base having photocatalytic activity; and
a silicon oxide film covering the base, wherein the film is substantially pore-free, and
wherein the photocatalyst has a alkali metal content of not less than 1 ppm but not more than 1,000 ppm.

2. The inorganic sintered material according to claim 1, wherein said silicon oxide film is a calcined silicon oxide film.

3. The inorganic sintered material according to claim 1, wherein said silicon oxide film is a calcined film obtained by calcining a silicon oxide at a temperature of not less than 200 degree centigrade but not more than 1,200 degree centigrade.

4. The inorganic sintered material according to claim 1, wherein said alkali metal content is not less than 10 ppm but not more than 1,000 ppm.

5. The inorganic sintered material according to claim 1, wherein said silicon oxide film does not have pores in the measurement of pore size distribution in the range of 20 to 500 Angstroms according to the nitrogen adsorption method.

6. The inorganic sintered material according to claim 1, wherein said base is anatase type titanium oxide or rutile type titanium oxide, or a mixture thereof.

7. The inorganic sintered material according to claim 1, wherein said alkali metal is sodium and/or potassium.

8. The inorganic sintered material according to claim 1, wherein said base is a particle.

9. The inorganic sintered material according to claim 1, wherein the amount of silicon supported on said photocatalyst per a surface area of 1 m² is not less than 0.10 mg but not more than 2.0 mg.

10. The inorganic sintered material according to claim 1, wherein the amount of silicon supported on said photocatalyst per a surface area of 1 m² is not more than 0.16 mg but not more than 1.25 mg.

11. The inorganic sintered material according to claim 1, wherein said base has a specific surface area of not less than 120 m²/g but not more than 400 m²/g.

12. The inorganic sintered material according to claim 1, wherein said photocatalyst has a sulfur content of 0.5 weight % or less based on the total weight of the photocatalyst.

13. The inorganic sintered material according to claim 1, wherein the alkali metal is contained in said silicon oxide film.

14. The inorganic sintered material according to claim 13, wherein the amount of the alkali metal contained in said silicon oxide film is not less than 1 ppm but not more than 200 ppm based on the total weight of the photocatalyst.

15. The inorganic sintered material according to claim 1, wherein said inorganic sintered material is pottery or a ceramic sintered material.

16. A method for producing pottery having a photocatalyst-containing surface layer on its surface, wherein the photocatalyst comprising a base having photocatalytic activity and a silicon oxide film covering the base, wherein the film is substantially pore-free, wherein the method comprising the following steps (A), (B) and (C):
(A) mixing at least any one combination of an aqueous medium containing the base and a silicate, an aqueous medium containing a silicate and the base, and an aqueous medium containing the base and an aqueous medium containing a silicate, and coating the base with the silicon oxide film;
(B) separating the photocatalyst composed of the silicon oxide film and the base covered with the silicon oxide film from the aqueous medium, and drying and/or calcining the resulted material; and
(C) attaching the photocatalyst covered with said silicon oxide film to a surface of unglazed pottery and subsequently firing the resulting material at a temperature of not less than 600 degree centigrade but not more than 1,500 degree centigrade; and
wherein the pH of a mixed solution containing both the base and a silicate in step (A) is maintained at 5 or less.

17. The method for producing pottery according to claim 16, in which said step of attaching said photocatalyst in said step (C) is a step of coating a glaze containing said photocatalyst on a surface of the unglazed pottery after the first firing.

18. The method for producing pottery according to claim 16, wherein the attaching said photocatalyst in said step (C) is coating a glaze and a dispersion containing a photocatalyst covered with said silicon oxide film in order or at the same time on a surface of the unglazed pottery after the first firing.

19. The method for producing pottery according to claim 16, wherein attaching said photocatalyst in said step (C) is applying a glaze on a surface of the unglazed pottery after the first firing and firing the resulting material at a temperature of not less than 600 degree centigrade but not more than 1,300 degree centigrade, and then coating a glaze containing a photocatalyst covered with said silicon oxide film thereon.

20. A method for producing pottery having a photocatalyst-containing surface layer on its surface, wherein the photocatalyst comprising a base having photocatalytic activity and a silicon oxide film covering the base, wherein the film is substantially pore-free, wherein the method comprising the following steps (A), (B) and (C) or (A), (B) and (D):
(A) mixing at least any one combination of an aqueous medium containing the base and a silicate, an aqueous medium containing a silicate and the base, and an aqueous medium containing the base and an aqueous medium containing a silicate, and coating the base with the silicon oxide film;
(B) separating the photocatalyst composed of the silicon oxide film and the base covered with the silicon oxide film from the aqueous medium, and drying and/or calcining the resulting material; and
(C) attaching the photocatalyst covered with said silicon oxide film to a surface of the ceramic sintered material and subsequently firing the resulting material at a temperature of not less than 600 degree centigrade but not more than 1,500 degree centigrade; or
(D) mixing the photocatalyst covered with said silicon oxide film with the raw material of said ceramic sintered material, molding the resulted mixture, and subsequently firing the resulting material at a temperature of not less than 600 degree centigrade but not more than 1,500 degree centigrade; and
wherein the pH of a mixed solution containing both the base and a silicate in step (A) is maintained at 5 or less.

21. The method for producing a ceramic sintered material according to claim 20, wherein attaching said photocatalyst in said step (C) is coating a dispersion containing a binder and the photocatalyst covered with said silicon oxide film on a surface of the ceramic sintered material.

22. The inorganic sintered material according to claim 5, wherein said base is anatase type titanium oxide or rutile type titanium oxide, or a mixture thereof.

23. The inorganic sintered material according to claim 5, wherein amount of silicon supported on said photocatalyst per a surface area of 1 m² is not less than 0.10 mg but not more than 2.0 mg.

24. The inorganic sintered material according to claim 6, wherein amount of silicon supported on said photocatalyst per a surface area of 1 m² is not less than 0.10 mg but not more than 2.0 mg.

25. The inorganic material according to claim 22, wherein amount of silicon supported on said photocatalyst per a surface area of 1 m² is not less than 0.10 mg but not more than 2.0 mg.

26. The inorganic sintered material according to claim 5, wherein the amount of silicon supported on said photocatalyst per a surface area of 1 m² is not more than 0.16 mg but not more than 1.25 mg.

27. The inorganic sintered material according to claim 6, wherein the amount of silicon supported on said photocatalyst per a surface area of 1 m² is not more than 0.16 mg but not more than 1.25 mg.

28. The inorganic sintered material according to claim 22, wherein the amount of silicon supported on said photocatalyst per a surface area of 1 m² is not more than 0.16 mg but not more than 1.25 mg.
